(19) United States
(12) Patent Application Publication
(10) Pub. No.: US 2005/0225647 A1
(43) Pub. Date: Oct. 13, 2005

(54) Method and system of creating photo vignettes

(76) Inventors: Richard Gossweiler III, Santa Clara, CA (US); Joshua R. Tyler, Palo Alto, CA (US); Patrick Goddi, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/822,110

(22) Filed: Apr. 9, 2004

(51) Int. Cl. H04N 5/232; G09D 3/02

(52) U.S. Cl. 348/211.3; 348/231.2

(57) ABSTRACT

In one embodiment, the present invention pertains to a method of creating photo vignettes. In one embodiment, the present invention accesses digitized photos. In the embodiment, the present invention also accesses photo-clustering parameters. The present embodiment then clusters the photos to obtain digitized photo vignettes, based on the photo-clustering parameters.

### TECHNICAL FIELD

Embodiments of the present invention relate to a method and system of creating and distributing photo vignettes.

### BACKGROUND ART

People enjoy telling stories through photos. They use photos to share stories about a wide range of topics including their life experiences, travels, family and the like. Typically, the photos are numerous and informal and are shared with friends and family, or are placed in the public domain.

From observations of people sharing photos, it is apparent that the sharing is not merely about sending individual photos for the sake of sharing pictures, but it is more about using photos to share a story about something that has happened in a short period of time and which was captured on photos.

With the proliferation of cell phones cameras and computer networks such as the Internet, people have yet another means to take and share photos. Using a cell phone camera, people can snap many informal, interesting photos and quickly transmit them to others on the network.

People also enjoy receiving interesting photos. To facilitate receiving photos on the network, there are a wide variety of digital display units available including digital picture frames, TV sets, personal digital assistants “PDA”, computer screens, cell phone displays and others.

While it is easy to imagine using a cell phone camera to take a short series of photos e.g., “My day at the Beach” or “Funny thing at the Park” and then beaming the set to a friend on the network. In practice the process is tedious and discouraging because of the many steps involved. For example, a user must first take a photo and preview it to make sure it is reasonable. Then, the user must type an email address on a cell phone keypad or navigate contact list menus and attach the photo thereto. Next, the user must press send and wait for the transmission to complete. These steps must be repeated for each photo. The process can get more tedious, or completely impractical, if the user wishes to string together several photos as a group to tell a story, or show the photos as a story to several people, and/or send them to storage for future storytelling.

Consequently because of the high cognitive load required to take and send photos, often photos do not get taken, or if taken, they are not presented in a meaningful way (e.g., to tell a story). Similarly upon receiving photos, because of the initiative and effort on the part of the receiver to receive and view the photos, the photos are not accessed or, if accessed, are not of interest because they are not presented in a meaningful way.

Besides the problems pertaining to taking and receiving photos that depict stories, other problems and inconveniences are also inhibiting people from using photos to tell stories. For example, due to a lack of presentation tools in the creator's repository of photo images to assemble photos into interesting stories, it is difficult for other people to see the photos as stories, or to see them as a more valuable aggregation around a story. Thus, the organization of the photos tend only to reflect the order of the photo submission to a repository, and their distribution is not differentiated to tell stories. Consequently, the distribution of the photos on networks tends to reflect a simple a list of pictures taken in chronological order and/or an icon list which is distributed to receivers without differentiation and without an apparent story line. Additionally, such systems may only utilize meta data to order the submitted photos without differentiating the photos to create a story.

Accordingly, in view of the problems and inconveniences described above, there is a need for a better way to take and share photos. Embodiments of the present invention address this need.

### DISLCOSURE OF THE INVENTION

In one embodiment, the present invention pertains to a method of creating photo vignettes. In one embodiment, the present invention accesses digitized photos. In the embodiment, the present invention also accesses photo-clustering parameters. The present embodiment then clusters the photos to obtain digitized photo vignettes, based on the photo-clustering parameters.

### BRIEF DESCRIPTION OF THE DRAWINGS

The accompanying FIGS. 1-3 incorporated herein to form a part of this specification illustrate embodiments of the invention by way of example and not by way of limitation. Except if specifically noted, these Figures should be understood as not being drawn to scale FIG. 1 is a block diagram illustrating a system for creating photo vignettes in accordance with an embodiment of the invention.

FIG. 2 is a flow chart illustrating a method of creating photo vignettes in accordance with an embodiment of the invention.

FIG. 3 is a block diagram illustrating a computer system useable for implementing an embodiment of the invention.

### MODES FOR CARRYING OUT THE INVENTION

Reference is now made to FIGS. 1-3 herein to describe in detail various embodiments of the invention. While the invention is described in conjunction with various embodiments and FIGS. 1-3, it is understood that this description is not intended to only limit the invention to the embodiments and Figures herein. On the contrary, the invention is intended to cover alternatives, modifications and equivalents that are within the scope of the appended claims.

In the following detailed description of the invention, specific details are set forth in order to describe the invention. It is understood however that the invention may be practiced without all of these specific details. In other instances, generally known methods, procedures and equipment have not been described in detail as not to unnecessarily obscure aspects of the invention.

In summary, embodiments of the invention comprises an end-to-end method and system for creating, storing, organizing, presenting and controlling the presentation of digitized photos as photo vignettes. A photo vignette is a clustering of photos carefully selected in accordance with photo-clustering parameters to tell a story and/or communicate information in a meaningful way. The end-to-end method and system, in one embodiment, allows for users to take photos and, with no further effort, have the photos presented as organized photo vignettes to viewers in a computer network. With the present method and system, the effort required by viewers to receive and view photo vignettes is also minimized.

### System for Creating Photo Vignettes

The following discussion will begin with a general description of a system for creating and distributing photo vignettes followed by a description of a method of operation of the system in accordance with embodiments of the present invention. With reference to FIG. 1, a photo-acquisition device 101 (e.g., a cell phone 102 with an integrated digital camera) is communicatively coupled with media repository 105 via communication network 150 (e.g., the Internet). In the embodiment of FIG. 1, photo-acquisition device 101 further comprises a user interface 103. In the present embodiment, media repository 105 comprises a photo accessor 106, photo clustering parameters 107, photo clusterer 108, photo distributor 109, and photo distribution parameters 110. In the present embodiment, photo distributor 109 is communicatively coupled with display device 111 via communication network 150.

In embodiments of the present invention, a user takes digitized photos using photo-acquisition device 101 and utilizes user interface 103 to select digitized photos for sending to media repository 105 and for including the digitized photos in photo vignettes (e.g., photo vignette 120). In one embodiment of the present invention, the digitized photos are then sent to media repository 105 wherein the digitized photos are stored. In embodiments of the present invention, the digitized photos stored by media repository 105 are accessed using photo accessor 106 and clustered according the photo clustering parameters 107 by photo clusterer 108 to create photo vignette 120. Alternatively, the digitized photos may be sent to another existing repository (not shown) and accessed via communication network 150 by photo accessor 106. In one embodiment, photo vignette 120 is stored by media repository 105. Thereafter, the photo vignette 120 are distributed to display unit(s) 111 by photo distributor 109 via communication network 150 in accordance with photo distribution parameters 110. In one embodiment, the distribution of photo vignette 120 is in response to a request for a photo vignette from display device 111. In embodiments of the present invention, photo vignette is created and distributed dynamically in response to a request from display device 111. In another embodiment, photo vignette 120 is automatically created and distributed to display device 111 according to photo distribution parameters 111.

As discussed above, in embodiments of the present invention, photo-acquisition device 101 comprises a cell phone with an integrated digital camera. However, it is be appreciated that embodiments of the present invention may utilize a variety of devices to create digitized photos including: cell-phone cameras, video cameras, digital cameras, computer cameras, a photo scanner, a conventional camera, a personal digital assistants PDAs, etc.

In embodiments of the present invention, the user utilizes user interface 103 to select digitized photos for storage in media repository 105. In accordance with the embodiments of the present invention, user interface 103 is any interface capable of displaying photo images and/or a user interface for accepting and displaying instructions for processing photo images. In one embodiment, user interface 103 comprises a message screen and a alphanumeric key pad (e.g., for taking and sending photo images, inputting email addresses, navigating through menu options and contact lists, etc.). In accordance with an embodiment of the invention, user interface 103 also comprises a software module containing executable instructions for taking and sending pictures with two consecutive clicks of a designated button of the alphanumeric key pad: a first click to take the picture and a second click to send the picture to media repository 105. In other embodiments of the present invention, user interface 103 may be controlled by a mouse, trackball, a touchpad, a joystick, and alpha-numeric keypad, voice control, etc.

As discussed above, in embodiments of the present invention, communication network 150 comprises the Internet. However, embodiments of the present invention are well suited for using other types of communication networks (e.g., an Ethernet network, a telecommunications network, a cellular telephone or other wireless network, etc.) for communicatively coupling photo-acquisition device 101 with media repository 105. Other examples of computer networks used in accordance with the present invention include general-purpose computer networks, embedded computer systems, laptop computer systems, hand-held computer systems, stand-alone computer systems and networked computer systems.

Media repository 105, in one embodiment, is a data storage system for storing digitized photos and meta data pertaining to the digitized photos. In embodiments of the present invention, meta data may comprise additional information which can be used to 200401713-1 classify the photos in the vignette in order to facilitate conveying a story to someone accessing the vignette. In embodiments of the present invention, the meta data may be used to annotate an entire photo vignette and/or one or more photos in a vignette. As an example, a photo vignette may be annotated with meta data to provide a title for the vignette of “A Day at the Beach.” Additional meta data annotated to digitized photos may caption particular events within the vignette such as “Arriving at the Beach,” “Eating Lunch,” “Playing Football,” etc. Media repository 105 also receives and stores photo clustering parameters 107 and creates photo vignettes (e.g., photo vignette 120) in accordance with photo clustering parameters 107. Additionally, media repository 105 uses photo distributor 109 to distributing photo vignette 120 in accordance with photo distribution parameters 1 10. In embodiments of the present invention, media repository 105 may be implemented as a single device (e.g., a photo vignette server) or in a distributed fashion (e.g., a computer network). Thus, in embodiments of the present invention, the functionality performed by media repository 105 in FIG. 1 (e.g., photo accessor 106, photo clustering parameters 107, and photo clusterer 108) may be implemented on photo-acquisition device 101.

In embodiments of the present invention, the digitized photos and appended meta data are sent from photo-acquisition device 101 to media repository 105 using email over a wireless communication channel (e.g., communication network 150) using, for example, either the simple mail transfer protocol (SMTP) or mail management system (MMS) over general packet radio service (GPRS). In one embodiment, a photo weblog site provides an email upload interface for photos from cell phone cameras is useable. One advantage of using this site is that it creates a Really Simple Syndication (RSS) feed. RSS is an extensible markup language (XML) protocol that is used as a delivery mechanism for information. RSS allows for writing specific viewers based on a well-known and defined XML syntax. However, in accordance with the present invention, one can use a variety of internet hosting sites that support an email server mechanism. Additionally, in one embodiment, media repository 105 is accessed by display device 111 via an Internet website.

In one embodiment, photo accessor 106 uses an initialization XML file to configure where to go for the RSS feed in media repository 105 and how frequently to check for updates to the RSS XML file. This initialization file also describes a mapping from the RSS tags to the fields that photo accessor 106 uses. This is necessary because there is no <IMAGE> tag in RSS, so different feeds provide images different ways. For example, one embodiment of the present invention places the image URL in the <DESCRIPTION> field.

Once started, photo accessor 106 periodically downloads the RSS files, and checks for new photo image URLs not already stored on display device 111. This downloading may be performed automatically or initiated by the user. New URLs are then downloaded and the complete set of images is then time-clustered by photo clusterer 108 into vignettes for distribution by photo distributor 109.

In embodiments of the present invention, photo clusterer 108 is a software application for clustering photo images into photo vignette 120. Clustering is the process of trying to identify groups of photos within a larger set for grouping. Photo clustering can be differentiated from conventional systems which merely order the photos in that photo clusterer 108 automatically segments, or creates groups of related photos according to some pre-defined photo clustering parameter. Thus, in accordance with embodiments of the present invention, photo clustering creates photo vignettes which are groups of related photos which tell a story. Conventional photo organization systems simply order the photos, typically reflecting the order of submission to a repository, without segmenting, or creating groups of related photos and therefore do not create a photo vignette as described in the present invention. In one embodiment, an algorithm based on the premise that people take closely related pictures together in time is used. In other embodiments, generally know clustering algorithms are used, based on photo-clustering parameters specified by users. Examples of photo-clustering parameters 107 include, but are not limited to: the time when the photos were taken, the geographic location at which the digitized were taken, the camera used to take the photos, the camera's position relative to the subject mater of the photos, a specified subject matter of the photos, the person who produced the digitized photos, the intended receiver of the digitized photo vignette 120, and the confidentiality classification of the subject matter of the photos. In embodiments of the present invention, meta data appended to a photo or group of photos may be used by photo clusterer 108 to create a photo vignette. In embodiments of the present invention, photo clusterer 108 creates groups of related photos automatically. However, a user can manually select photos to create a photo vignette as well.

After the photos are clustered into photo vignettes, photo distributor 109 is used to distribute the photos vignettes to end viewers. In one embodiment, photo distributor 109 rotates through each photo vignette to determine how the photo vignette is to be presented to the end viewer. In one embodiment a photo vignette can be presented in a variety of ways, based on a selected photo distribution parameter 1 10 and a template. For example, a photo vignette can be clustered to be shown as a slide show wherein each photo image is saved with an associated HTML file. In this example photo distributor 109 uses an IE COM object to show the HTML page, then fade to the next HTML-enveloped image. In another example, the photo vignette can be clustered for showing as a comic strip that animates through each frame of the comic strip by highlighting one frame while leaving the other cells in the background. This is accomplished using a series of HTML files for each animation section.

Photo distribution parameters 110 are also used by photo distributor 109 to selectively distribute photo vignette 120 created by photo clusterer 108. In embodiments of the present invention, photo distribution parameters 110 may include, but are not limited to: the time when the digitized photos were taken, the geographic location at which the digitized photos were taken, the camera used to take the digitized photos, the camera's position relative to the subject mater of the digitized photos, a specified subject matter of the digitized photos, the person who produced the digitized photos, the intended receiver of the digitized photo vignette 120, and the confidentiality classification of the subject matter of the photos. Additionally, photo distributor 109 may also use photo clustering parameters 107 in to selectively distribute photo vignette 120 created by photo clusterer 108.

In embodiments of the present invention, display device 111 may comprise a personal computer, a personal digital assistant, a digital picture frame, a set-top box, a television, a cellular telephone, or other device capable of displaying images. In an embodiment of the present invention, photo accessor 106, photo clustering parameters 107, photo clusterer 108, photo distributor 109, and photo distribution parameters 110 can reside on display device 111. For example, in one embodiment, photo accessor 106, photo clusterer 108 and photo distributor 109 comprises a software application module that cooperate to form a local browser for end user to view the photo vignette 120 on local display device 111. In operation, photo accessor 106 checks for new photos in media repository 105, using an RSS feed from media repository 105. If new images are available, photo clusterer 108 is used to cluster the photos into photo images according to photo clustering parameters 107, while photo distributor 109 is used to download new images onto display device 111 for viewing in accordance with photo distribution parameters 110.

The following discussion will explain how photo vignettes are created and distributed in accordance with embodiments of the present invention. A user at a company picnic takes photos of various activities throughout the day. These activities include a barbeque, a tour of the company facilities, an employee volleyball game, an ice cream break, and an awards ceremony for the employees. The user selects photos for uploading to media repository 105 utilizing user interface 103. Photo clustering parameters 107 are accessed by photo clusterer 108 to cluster related groups of photos (e.g., photo vignettes) according to the activity shown in the photos (e.g., the barbeque, the tour of the facilities, the volleyball game, the ice cream break, and the awards ceremony).

Because some of the photos may show images which could be included into more than one of the vignettes created by photo clusterer 108 (e.g., some of the photos of the award ceremony also show people eating ice cream), the user may manually designate including selected photos into a specific photo vignette. Furthermore, embodiments of the present invention may also exclude photos from a photo vignette in accordance to the photo clustering parameters 107. For example, in order to prevent including two photos of the same subject matter in a photo vignette, photo clusterer 108 may select one of the photos and omit or discard the other photo.

Photo distributor 109 accesses the photo distribution parameters 110 in order to determine which recipients will receive a specific photo vignette. Because the user may want to restrict some of the photos to specific groups of recipients, distribution of the photo vignettes is performed in accordance with the photo distribution parameters 110. Thus, while company employees can receive all of the photo vignettes created by photo clusterer, someone who is not a company employee may not be authorized to receive the photo vignette of the tour of the company facilities in order to protect sensitive company information. Thus, non employees do not receive a photo vignette of the company facilities tour.

### Method of Operation for Creating Photo Vignettes

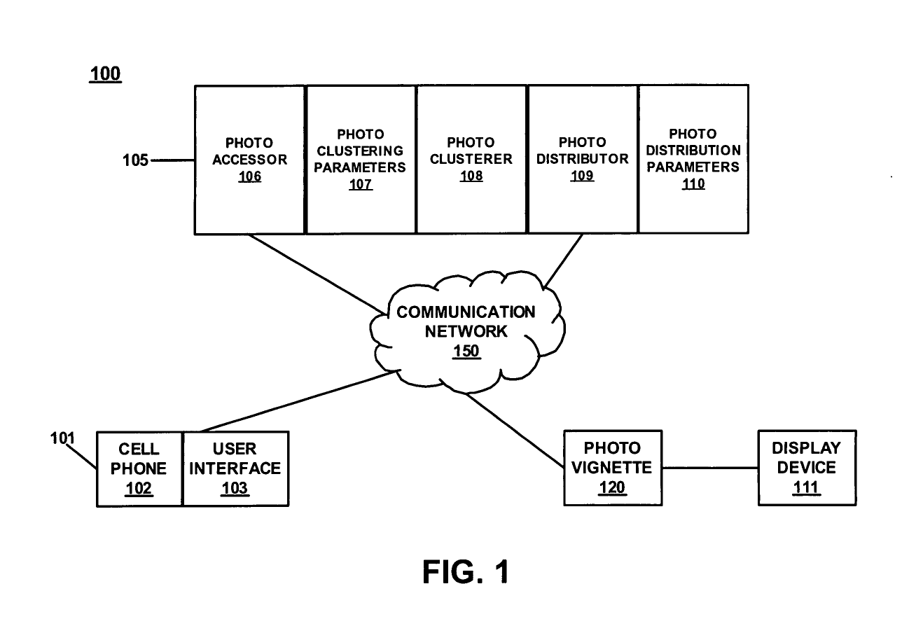

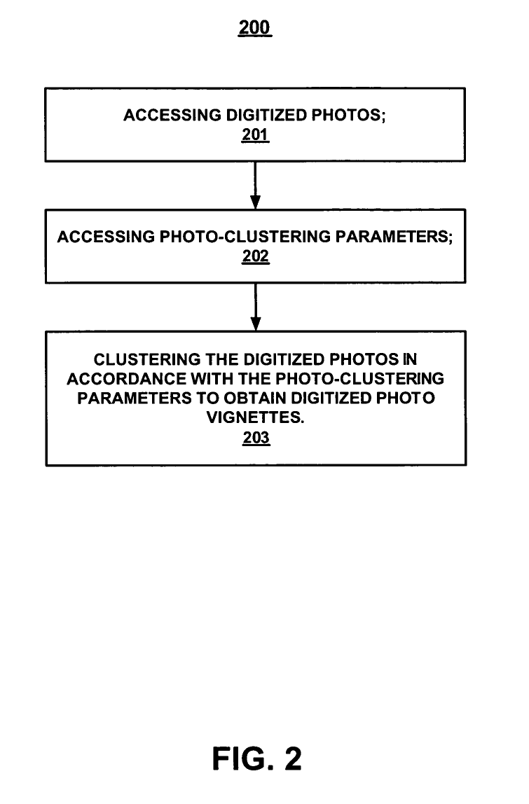

FIG. 2 is a flow chart 200 illustrating a method of creating photo vignettes in accordance with an embodiment of the present invention. With reference to FIGS. 1 and 2, in one embodiment, step 201 of FIG. 2 comprises accessing digitized photos. In one embodiment, the digitized photos are accessed from media repository 105 by photo accessor 106 using the hyper-text transfer protocol (HTTP). In accessing the digitized photos, an RSS XML file is downloaded and read for media names. The media names are compared with media names already on a local digital display device (e.g., display device 111). If required, new media not displayed on display device 111 are downloaded from media repository 105. In one embodiment the digitized photos are accessed from multiple photo-acquisition devices 101 that located at geographically separated locations.

In step 202, the present method comprises accessing photo-clustering parameters. In one embodiment, photo-clustering parameters are accessed from media repository 105 using photo accessor 106. Photo-clustering parameters are the parameters used to determine the clustering of the photos into photo vignette 120. Examples of photo-clustering parameters include the time when said digitized photos were taken, the geographic location at which the digitized photos were taken, the camera used to take said digitized photos, the camera's position relative to the subject mater of said digitized photos, a specified subject matter of said digitized photos, the person who produced said digitized photos, a receiver of said digitized photo vignette 120, and the confidentiality classification of the subject matter of said digitized photos

In step 203, digitized photos are clustered in accordance with specified photo-clustering parameters 107, to obtain digitized photo vignette 120. Clustering is done by photo clusterer 108. In one embodiment, after clustering, HTML picture frames are generated and presented for viewing using display device 111. To avoid one story overlapping onto another each story is told in one vignette. Consequently, stories never get overwritten. Typically, stories that are produced are kept in media repository 105 from which they can be accessed.

Although specific steps of embodiments of the invention are set forth in flowcharts 200 it should be noted that such steps are exemplary. That is, embodiments of the invention can be performed by various other steps or steps equivalent to those steps set forth in flowchart 200. Also, the steps in flowcharts 200 may be performed in an order different than presented, and not all of the steps in flowchart 200 may be performed. All of, or a portion of, the method set forth in flowcharts 200 may be implemented using computer-readable and computer-executable instructions which reside, for example, in computer-usable media of a computer system 300 or like device. In one embodiment, the steps of flowchart 200 can be implemented by the exemplary computer system 300 of FIG. 6 described below.

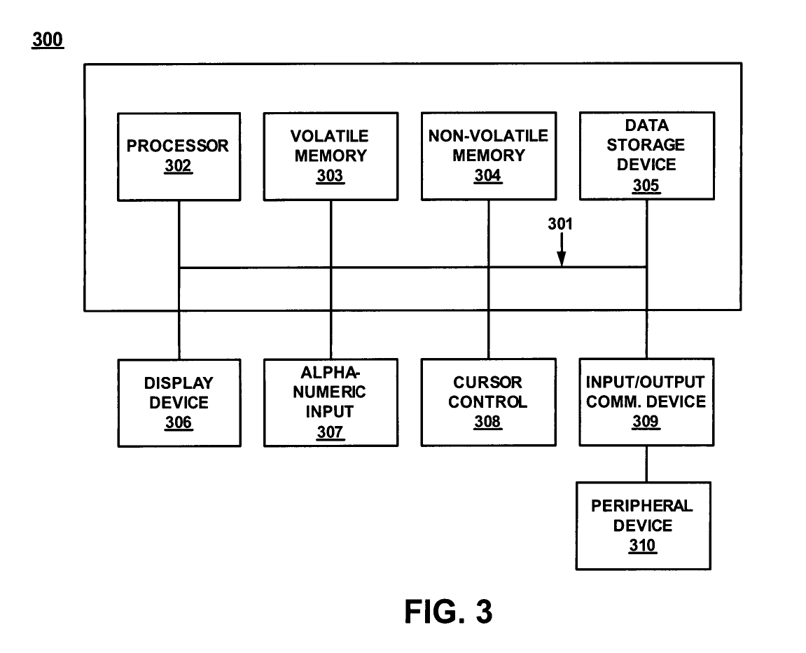

Embodiments of the invention are comprised of computer-readable media and computer-executable instructions that reside, for example, in computer system 300 of FIG. 3, which may be a part of a general purpose computer network not shown, or may be a stand-alone computer system. It will be appreciated that computer system 300 of FIG. 3 is exemplary only and that the invention can operate within a number of different computer systems including general-purpose computer systems, embedded computer systems, laptop computer systems, hand-held computer systems, stand-alone computer systems, PDA's, TV sets, cell phones, photo frames and networked computer systems including the Internet.

In one embodiment, computer system 300 includes an address/data bus 601 for conveying digital information between the various components, a central processor unit CPU 302 for processing the digital information and instructions, a volatile main memory 303 comprised of volatile random access memory RAM for storing the digital information and instructions, and a non-volatile read only memory ROM 304 for storing information and instructions of a more permanent nature. In addition, computer system 300 may also include a data storage device 305 e.g., a magnetic, optical, floppy, semiconductor or tape drive or the like for storing data. It should be noted that the software program comprising method of creating photo vignettes, comprising: accessing digitized photos; accessing photo-clustering parameters; and clustering said digitized photos in accordance with the photo-clustering parameters to obtain digitized photo in accordance with an embodiment of the invention can be stored either in volatile memory 303, data storage device 305, or in an external storage device not shown.

Devices which are optionally coupled to computer system 300 include a display device 306, 1 1 1 for displaying information to a computer user, an alpha-numeric input device 307 e.g., a keyboard, and a cursor control device 308 e.g., mouse, trackball, light pen, etc. for inputting data, selections, updates, etc. Computer system 300 can also include a mechanism for emitting an audible signal not shown. Optional display device 306 of FIG. 3 may be a liquid crystal device, cathode ray tube, or other display device suitable for creating graphic images and alpha-numeric characters recognizable to a user.

Computer system 300 can include an input/output I/O signal unit e.g., interface 109 for interfacing with a display device 111. Accordingly, computer system 300 may be coupled in a network, such as a client/server system, whereby a number of clients e.g., personal computers, workstations, portable computers, minicomputers, terminals, etc. are used to run processes for performing desired tasks e.g., “accessing”, “clustering”, “enabling,” etc.. In particular, computer system 100 can be coupled in a system for executing a software application program that embodies aspects the invention.

Some portions of the above-described detailed description are presented in terms of steps, procedures and other symbolic representations of operations on data bits within a computer memory. These descriptions and representations are the means generally used by those ordinarily skilled in the pertinent art to effectively convey the substance of their work to others ordinarily skilled in the art. A step, procedure, process, etc., is here generally conceived to be a sequence of steps or instructions that guide operations of a computer system to a desired result. The steps include physical manipulations of physical quantities. Usually, though not necessarily, these quantities take the form of electrical, magnetic, optical, laser or quantum signals capable of being stored, transferred, combined, compared, and otherwise manipulated in a computer processing system. It is convenient at times, principally for reasons of common usage, to refer to these signals as bits, values, elements, symbols, characters, terms, numbers, or the like.

It should be noted that all of these and similar terms are associated with the appropriate physical quantities and are merely convenient labels applied to these quantities. Unless specifically stated otherwise as apparent from the following discussions, it is appreciated that throughout the present description, discussions utilizing terms such as “accessing”, “clustering”, “distributing”, “storing”, “transmitting”, “using”, “displaying” and the like, refer to the action and processes of a computer system, or similar processing device e.g., an electrical, optical, or quantum computing device, that manipulates and transforms data represented as physical e.g., electronic quantities. The terms refer to actions and processes of the processing devices that manipulate or transform physical quantities within a computer system's components e.g., registers, memories, other such information storage, transmission or display devices, etc. into other data similarly represented as physical quantities within the same or other components.

The foregoing description of embodiments of the invention has been presented for purposes of illustration and description. They are not intended to be exhaustive or to limit the invention to the precise forms described, and obviously many modifications and variations are possible in light of the above teaching. The embodiments were chosen and described in order to best describe the invention and its practical application. It is intended that the scope of the invention be defined by the claims appended hereto and their equivalents.

1. A method of creating photo vignettes, said method comprising:
accessing digitized photos;
accessing photo-clustering parameters; and
clustering said digitized photos in accordance with said photo-clustering parameters to obtain digitized photo vignettes.

2. The method as recited in claim 1, further comprising:
accessing a photo-distribution parameter; and
enabling selective distribution of said digitized photo vignettes in accordance with said photo-distribution parameter.

3. The method as recited in claim 2, wherein said photo-distribution parameter is selected from the group consisting essentially of:
the time when said digitized photos were taken, the geographic location at which the digitized photos were taken, the camera used to take said digitized photos, the camera's position relative to the subject mater of said digitized photos, a specified subject matter of said digitized photos, the person who produced said digitized photos, a receiver of said digitized photo vignettes, and the confidentiality classification of the subject matter of said digitized photos.

4. The method as recited in claim 1, wherein said photo-clustering parameter is selected from the group consisting essentially of:
the time when said digitized photos were taken, the geographic location at which the digitized photos were taken, the camera used to take said digitized photos, the camera's position relative to the subject mater of said digitized photos, a specified subject matter of said digitized photos, the person who produced said digitized photos, a receiver of said digitized photo vignettes, and the confidentiality classification of the subject matter of said digitized photos.

5. The method as recited in claim 1, wherein said digitized photos are obtained by using a photo-acquisition device selected from the group consisting essentially of:
a digitized cell-phone camera, a video camera, a computer camera, a Personal Digital Assistant, a conventional camera, an existing repository, and a photo scanner camera.

6. The method as recited in claim 1, further comprising:
annotating at least a portion of said digitized photo vignettes with meta data pertaining to said digitized photo vignettes.

7. A system for inducing acquisition of photo images, said system comprising:
a photo-accessor for accessing photo images;
a photo-clusterer for clustering said photo images to obtain digitized photo vignettes; and
a photo-distributor for enabling selective distribution of said digitized photo vignettes such that a user is enabled to freely acquire said photo images and have said photo images automatically clustered into said digitized photo vignettes for selective distribution.

8. The system of claim 7, further comprising:
a media repository for storing said photo images and said digitized photo vignettes.

9. The system of claim 7, wherein said photo-accessor is configured to access digitized photo images acquired from a photo-acquisition device selected from the group consisting essentially of:
a digitized cell-phone camera, a video camera, a computer camera, a Personal Digital Assistant, a conventional camera, an existing repository, and a photo scanner.

10. The system of claim 7, wherein said photo-distributor comprises a digitized photo presentation module.

11. A computer-readable medium comprising computer executable instructions stored therein, said instructions for causing a computer system to perform a method of creating photo vignettes, said method comprising:
accessing digitized photos;
accessing photo-clustering parameters; and
clustering said digitized photos in accordance with said photo-clustering parameters to obtain digitized photo vignettes.

12. The computer-readable medium of claim 11, wherein said method further comprises:
accessing a photo-distribution parameter; and
enabling selective distribution of said digitized photo vignettes in accordance with said photo-distribution parameter.

13. The computer-readable medium of claim 12, wherein said photograph-distribution parameter is selected from the group consisting essentially of:
the time when said digitized photos were taken, the geographic location at which the digitized photos were taken, the camera used to take said digitized photos, the camera's position relative to the subject mater of said digitized photos, a specified subject matter of said digitized photos, the person who produced said digitized photos, a receiver of said digitized photo vignettes, and the confidentiality classification of the subject matter of said digitized photos.

14. The computer-readable medium of claim 11, wherein said photo-clustering parameter is selected from the group consisting essentially of:
the time when said digitized photos were taken, the geographic location at which the digitized photos were taken, the camera used to take said digitized photos, the camera's position relative to the subject mater of said digitized photos, a specified subject matter of said digitized photos, the person who produced said digitized photos, a receiver of said digitized photo vignettes, and the confidentiality classification of the subject matter of said digitized photos.

15. The computer-readable medium of claim 11, wherein said photo images are obtained by using a photo-acquisition device selected from the group consisting essentially of:
a digitized cell-phone camera, a video camera, a computer camera, a Personal Digital Assistant, a conventional camera, an existing repository, and a photo scanner camera.

16. The computer-readable medium of claim 11, wherein said method further comprises:
annotating at least a portion of said digitized photo vignettes with meta data pertaining to said digitized photo vignettes.

17. The computer-readable medium of claim 1 1, comprising a digital storage device including a CD, a diskette, a video cassette, electronic mail and a digital memory device.
